(19) United States
(12) Patent Application Publication
(10) Pub. No.: US 2024/0144242 A1
(43) Pub. Date: May 2, 2024

(54) A SYSTEM AND METHOD OF PROVIDING A BLOCKCHAIN-BASED CURRICULUM VITAE

(71) Applicant: C Squared Ventures Ltd., London (GB)

(72) Inventor: Richard Collins, Chiddingfold (GB)

(21) Appl. No.: 18/497,109

(22) Filed: Oct. 30, 2023

Related U.S. Application Data
(60) Provisional application No. 63/381,830, filed on Nov. 1, 2022.

(51) Int. Cl. G06Q 20/36; G06Q 20/38; G06Q 20/40

(52) U.S. Cl. CPC G06Q 20/36; G06Q 20/389; G06Q 20/401

(57) ABSTRACT

Technologies for systems, methods and computer-readable storage media for providing a smart curriculum vitae in a blockchain wallet. The method includes providing a blockchain-based wallet to a user device, the blockchain-based wallet being associated with a user and being associated with a blockchain network, creating, for the user, a smart curriculum-vitae stored within the blockchain-based wallet, receiving, from a third party, information associated a qualification associated with the user and creating a record on the blockchain network that confirms the qualification associated with the user. The method can include storing, upon the user claiming the qualification, the data associated with the qualification in the blockchain-based wallet and in connection with the smart curriculum-vitae and transmitting, from the blockchain-based wallet, the smart curriculum-vitae to a potential employer computer for a job, wherein the potential employer uses the smart curriculum-vitae to verify the qualification of the user.

### PRIORITY CLAIM

The present application claims priority to U.S. Provisional Application No. 63/381,830, filed on Nov. 1, 2022, the contents of which are incorporated herein by reference.

### TECHNICAL FIELD

The present disclosure generally relates to new approaches to providing a curriculum vitae (CV) or resume storing blockchain-based verified experience and a new ecosystem that provides potential employers, potential employees and assessors the ability to participate in providing and using a smart CV or a smart resume.

### BACKGROUND

The current hiring process is no longer appropriate for today's working conditions. People often use assessments to test for skills and abilities and many people work and hire remotely. People also often work multiple jobs. Even in such a unique environment, employers still use an outdated curriculum vitae (CV).

In 1482, Leonardo DaVinci wrote to the Duke of Milan setting out his skills and experience to ask for employment, and by doing so is credited with the invention of the CV. Today, the CV remains relatively unchanged. The world of work has changed beyond all recognition and companies have shifted to skills-based recruiting and rapidly adopted automated hiring technology whilst employees work remotely, do gigs and work flexibly. These existing processes leave the CV firmly stuck in the dark ages.

In an application process, a 95% drop out rate is considered normal and storing CVs in a database can also be a privacy and security problem. To the degree that a potential employer seeks to verify user credentials, the process of confirming a credential with a reference can border on stalking. Because of the hiring challenges, as many as a third of new hires leave within ninety days.

### BRIEF DESCRIPTION OF THE FIGURES

To provide a more complete understanding of the present disclosure and features and advantages thereof, reference is made to the following description, taken in conjunction with the accompanying drawings, in which:

FIG. 1 illustrates a general blockchain network representing different nodes each communicating with each other, according to some aspects of the present disclosure;

FIG. 2 illustrates the general components associated with the blockchain-based curriculum vitae, according to some aspects of the present disclosure;

FIG. 3 illustrates an example smart CV showing object representing one of three levels of verification for each item, according to some aspects of the present disclosure;

FIG. 4 illustrates an example dashboard for use by assessors, according to some aspects of the present disclosure;

FIG. 5 illustrates a user interface to the CV wallet for performing certain tasks, according to some aspects of the present disclosure;

FIGS. 6A-6C illustrate the workflow and architecture for the smart CV wallet and associated systems, according to some aspects of the present disclosure;

FIG. 7 illustrate an example method associated with the use of distributed wallet technology, according to some aspects of the present disclosure;

FIG. 8 illustrates an example method for storing skills assessments as part of a verified CV, according to some aspects of the present disclosure;

FIG. 9 illustrates an example method for referencing using the blockchain verified CV, according to some aspects of the present disclosure;

FIG. 10 illustrates and example method of making job offers directly to people based on skills assessments completed and verified, according to some aspects of the present disclosure;

FIG. 11 illustrates an example method for job seekers to create a unique QR code to share CVs from a mobile device, according to some aspects of the present disclosure;

FIG. 12 illustrates an example method of providing a blockchain-based CV, according to some aspects of the present disclosure; and

FIG. 13 illustrates an example network device suitable for, according to some aspects of the present disclosure

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Disclosed herein are systems, methods and computer-readable storage media for applying the latest Web3 technologies such as a blockchain network and decentralized wallets to improve the use of the curriculum vitae (CV) and the overall hiring process. The new approach can use non-fungible tokens (NFTs) as digital qualifications and can make skills assessments portable. The disclosure re-imagines the overall hiring ecosystem and presents a new infrastructure to help people find work and how companies attract talent in a way that fits in today's workplace.

This overview is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The approach disclosed herein addresses several points raised above. One aspect of this disclosure introduces a new CV that can have experiences listed for the person that are verified on a blockchain network.

In some aspects, a method can include providing a blockchain-based wallet to a user device, the blockchain-based wallet being associated with a user and being associated with a blockchain network; creating, for the user, a smart curriculum-vitae stored within the blockchain-based wallet; receiving, from a third party, information associated a qualification associated with the user; creating a record on the blockchain network that confirms the qualification associated with the user; storing, upon the user claiming the qualification, the data associated with the qualification in the blockchain-based wallet and in connection with the smart curriculum-vitae; and transmitting, from the blockchain-based wallet, the smart curriculum-vitae to a potential employer computer for a job, wherein the potential employer uses the smart curriculum-vitae to verify the qualification of the user.

In some aspects, a system can include a processor and a computer-readable storage device storing instructions which, when executed by the processor, cause the processor to perform operations including: providing a blockchain-based wallet to a user device, the blockchain-based wallet being associated with a user and being associated with a blockchain network; creating, for the user, a smart curriculum-vitae stored within the blockchain-based wallet; receiving, from a third party, information associated a qualification associated with the user; creating a record on the blockchain network that confirms the qualification associated with the user; storing, upon the user claiming the qualification, the data associated with the qualification in the blockchain-based wallet and in connection with the smart curriculum-vitae; and transmitting, from the blockchain-based wallet, the smart curriculum-vitae to a potential employer computer for a job, wherein the potential employer uses the smart curriculum-vitae to verify the qualification of the user.

In some aspects, a system can include a processor and a computer-readable storage device storing instructions which, when executed by the processor, cause the processor to perform operations. The operations can include creating, for the user, a smart curriculum-vitae stored within the blockchain-based wallet; receiving, from a third party, information associated a qualification associated with the user; creating a record on the blockchain network that confirms the qualification associated with the user; storing, upon the user claiming the qualification, the data associated with the qualification in the blockchain-based wallet and in connection with the smart curriculum-vitae; and transmitting, from the blockchain-based wallet, the smart curriculum-vitae to a potential employer computer for a job, wherein the potential employer uses the smart curriculum-vitae to verify the qualification of the user.

In some aspects, a computer-readable storage device can store instructions which, when executed by one or more processor, cause the one or more processor to perform operations including: creating, for a user, a smart curriculum-vitae stored within a blockchain-based wallet using a blockchain network; receiving, from a third party, information associated a qualification associated with the user; creating a record on the blockchain network that confirms the qualification associated with the user; storing, upon the user claiming the qualification, data associated with the qualification in the blockchain-based wallet and in connection with the smart curriculum-vitae; and transmitting, from the blockchain-based wallet, the smart curriculum-vitae to a potential employer computer for a job, wherein a potential employer uses the smart curriculum-vitae to verify the qualification of the user.

The foregoing, together with other features and embodiments, will become more apparent upon referring to the following specification, claims, and accompanying drawings.

### EXAMPLE EMBODIMENTS

Disclosed are systems, methods, and computer-readable storage media that provide an approach to enabling a potential employer or person who is evaluating the curriculum vitae (CV) of a potential employee to have confidence in the experience listed in the CV. The disclosure includes a workflow that provides various interactions that occur with the system to both confirm experience and retrieve the CV and view the details of the CV with confidence. Note that as used herein, a CV wallet can also be characterized as a resume wallet in which the term CV or resume or other term can be applied to any listing or identification of a person's background, capabilities, work history, work experience, and so forth.

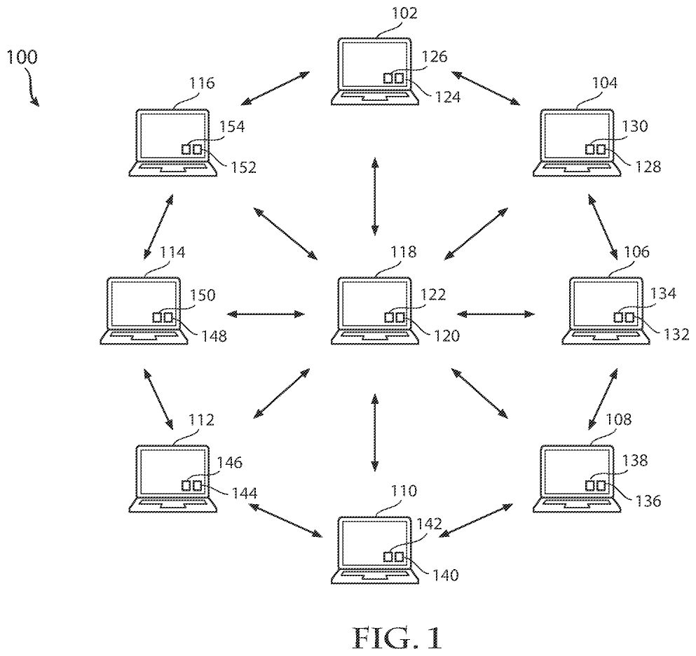

As a blockchain network is part of this disclosure, FIG. 1 illustrates a general blockchain network representing different nodes each communicating with each other, according to some aspects of the present disclosure. The blockchain network 100 includes a plurality of distributed nodes or computing devices 102, 104, 106, 108, 110, 112, 114, 116, 118. Each of these nodes and computing devices includes a component, module or software as part of a distributed consensus algorithm 120, 124, 128, 132, 136, 140, 144, 148, 152 in which transactions that are to be processed by the blockchain network are voted upon by the distributed consensus algorithm. Blockchain networks 100 have various consensus mechanisms, including proof of stake, multi-signature, and PBFT (practical Byzantine fault tolerance). Other approaches to consensus are also provided herein.

Another component, module or software provide a distributed ledger 122, 126, 130, 134, 138, 142, 146, 150, 154. The general operation of the blockchain is that it will record across the distributed ledger 122, 126, 130, 134, 138, 142, 146, 150, 154 transactions that are voted upon by the consensus algorithm 120, 124, 128, 132, 136, 140, 144, 148, 152. The recorded transactions (such as a sale or transfer of a cryptocurrency, or a confirmation of an event or of a validity of a document), are immutable in that the way the distributed ledger works is through adding blocks of data (or a group of transactions) to the ledger in which each block is connected via a hash to data in a previous block. The blockchain network 100 is a distributed database that maintains a continuously growing list of ordered records, called blocks. The blocks are linked using cryptography. Each block contains a cryptographic hash of the previous block, a timestamp, and transaction data. The blockchain network 100 is a decentralized, distributed and public or private digital ledger that is used to record transactions across many computers so that the record cannot be altered retroactively without the alteration of all subsequent blocks and the consensus of the network. The data regarding a transaction proceeds through a transition from one state (the pre-ledger state) which could be hacked or shared to another state (a post-ledger state) in which the transaction or data is immutable to the extent that the transaction cannot be altered without the consensus of the blockchain network 100. These characteristics cannot be obtained via a generic computer storing data in a memory. In such a case, the structure of a generic computer does not enable immutable storage of data on the memory of the computer.

The blockchain network 100 can be used to record data or transactions related to a number of different use cases. While the blockchain has many uses, the primary use as disclosed herein is connected with providing verified credentials, user identity, experience and skills assessments associated with a CV of a user. The blockchain 100 can in the context of this disclosure be called a qualified blockchain 100 in that it is used to confirm user qualifications. The Web3 approach disclosed herein introduces a hiring ecosystem that improves on every aspect of the traditional hiring system. The experience, personality and old school hiring is replaced with ability and skills-based hiring. The centralized CV database is replaced with a secure, decentralized user-controlled database wherein the CV can be stored in the user's wallet on their user device 210. Employers, rather than advertising for the job and hoping for the right applicants, the job offers can be provided to those with the right skills. Rather than a less diverse workforce, the workforce can be more diverse based on ability. Rather than the employer calling for references at the end of the process, the data can be blockchain-verified at the start. Instead of a word-based CV, the new approach can provide an app-based smart CV structured to show the level of verification for each item. Rather than desktop job hunting, the approach provides a mobile-based employer choosing process. The traditional process is also very slow and this new approach is immediate and automated. Finally, there is no need to print out a physical CV, in that the user can provide a scanned CV via a QR code.

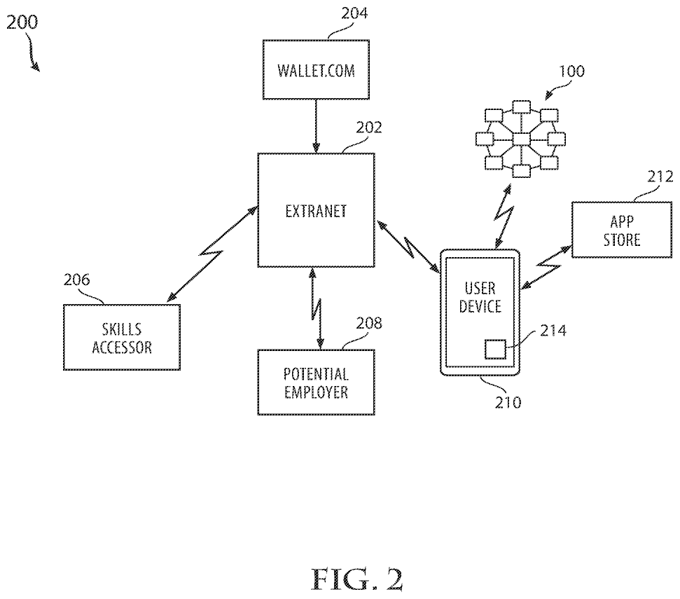

FIG. 2 illustrates the network 200 and various components that provide a blockchain-based solution to the hiring process. The system includes an extranet 202 that manages the various interactions via a portal 204 or website that enables access to the extranet 202 with participants such as skills accessor 206 which can be an entity that confirms that a user has completed a skills assessment, a potential employer 208 who may access the extranet 202 seeking information in a CV about a potential hire, a user device 210 associated with a user who desires a job, an “app store” from which the user can download a blockchain-based wallet and the blockchain network 100 that will interact with the extranet 202 and the user device 210.

The assessment provider or skills assessor 206 can be skilled or academically based and can store qualifications and assessments on the blockchain 100 that can be independently verified. This promotes a more fair and less biased recruiting process through skills-based hiring. This approach also makes skills more portable and connects assessed candidates directly to their employers and eliminates the need for manual referencing. This approach can re-establish trust and eliminate CV qualifications fraud which can often occur when a potential hire is dishonest in their credentials. Users can access the extranet 202 and claim their verified skills assessments and qualifications and store such proven verifications in their wallet on their device 210.

The approach disclosed herein extends the blockchain use to include a capability that focuses on people's experience. The system can integrate with human resources (HR) technology providers to enable the required verification process. For example, an HR application can be upgraded with the ability to access the extranet 202 and provide a confirmation of a successful assessment for the user.

The potential employer 208 can access the extranet 202 and experience a skills-based hiring platform where they can make direct offers to relevant, qualified, and blockchain-verified candidates. The employer search can be based on user's skills and assessments before making offers directly to relevant, qualified candidates. Employers are able to immediately check and verify applicant skills/qualifications and identity. The extranet 202 enables employers to verify jobseeker qualifications and assessments and provides a secure decentralized CV database where users hold and control their own data. The approach can be fully automated, frictionless hiring of pre-qualified candidates, straight to offers—skipping all the slow application stages.

The system can build in a revenue stream for skills assessors 206 for example when an employer 208 checks an applicant that the assessor has verified, a payment can be made.

A job-seeker 210 can store blockchain-verified assessments and qualifications along with their CV in a secure decentralized wallet, where they have complete control over their personal data and who they share their personal data with. The wallet 214 can be downloaded to the user device 210 from an “app store” 212 or similar database. The approach upgrades and replace the traditional CV with a smart CV. The CV can be moved from the desktop to the mobile device 210. This approach protects people from identity theft and can create a career-long tool that grows with the individual user.

In one aspect, the wallet 214 can include a chatbot assistant to help build their CV or resume. A detailed order of questions and answers can be provided through the use of the chatbot to fill in the details of the CV and which can trigger interactions with accessors and/or employers as the CV is populated. The smart CV disclosed herein that can be stored in the wallet 214 introduces new functionality not previously contemplated or available when using traditional CVs.

The wallet 214 enables the user to share their CV from their phone via QR codes, the wallet, email pdfs, AirDrop, and print. The wallet 214 is easy to use to set up multiple CVs (with chat bot assistant), skills verification and storage, free NFTs of user qualifications, smart CV tools, job searching and the ability to create search alerts right within the wallet 214, and the ability to get direct job offers based on skills assessments. The wallet 214 can also be integrated into other wallets such as the Apple Wallet where notifications and CVs can be stored as well. The overall approach can also be characterized as a Web2.5 approach which can combine both Web2 and Web3 technologies.

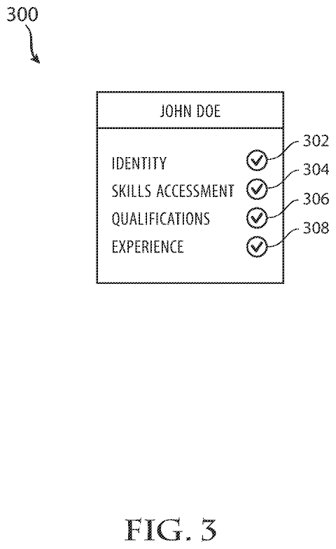

FIG. 3 shows a new structure for the CV 300. The CV can be structured with different aspects such as the user identity, skills assessment, qualifications and experience. Each of these various aspects can be verified as shown in the verification objects 302, 304, 306, 308. Each aspect is verified in one of a plurality of different ways. For example, the system may enable three different types of verification: (1) Self-verification in which the user confirms the information. The self-verification approach is the weakest form of verification as can be recognized but the CV can show that an aspect is self-verified. (2) Another type of verification is a verification with proof. The proof-based verification can include an upload of a certificate of completion or a form that proves the person graduated from college or a trade school. In one aspect, the physical proof (diploma or other certification) can have an associated non-fungible token (NFT) minted for that proof. NFTs are unique cryptographic tokens that exist on a blockchain and cannot be replicated. They can be created in connection with an assessment or certificate (such as a diploma of a person or a certificate of a skills assessment) such that it is a unique representation of that physical proof of user achievement. NFTs can also function to represent an individual's identity, a property rights, and can also relate to a unique token connected with a skills assessment event when there is no physical counterpart such as a certificate as noted above. For example, an assessor may provide data to the extranet 202 to confirm that the user has completed a training course in a software programming language. An NFT may be minted and recorded on the blockchain network but the token can be related to the achievement confirmed by the assessor but not a physical document.

The user's wallet may or may not include the respective NFT. The CV 300 can include a reference to an NFT where applicable for an item in the CV. The system is able to store skills assessments and qualifications as NFTs. (3) A blockchain-based verification can be provided from a third party 206. For example, a college, or trade association or skills assessment entity can have an account with the extranet 202 and when a person completes a test, skill, class, or college degree, and so forth, the third party can access the extranet and confirm via an interaction with system that the user has completed the task. The third-party blockchain-based skills assessment can be the highest form of verification of the user's experience as it comes from a third party. The data associated with that experience can be stored on the blockchain and confirmed via an object 302, 304, 306, 308 in the user's CV. Note that while the objects are all checkmarks in FIG. 3, that different objects, colors or other types of indicators can be provided for the different levels of verification. For example, a self-verification might be orange, a physical proof or NFT of the physical proof might be yellow and the third party blockchain-based verification might be blue.

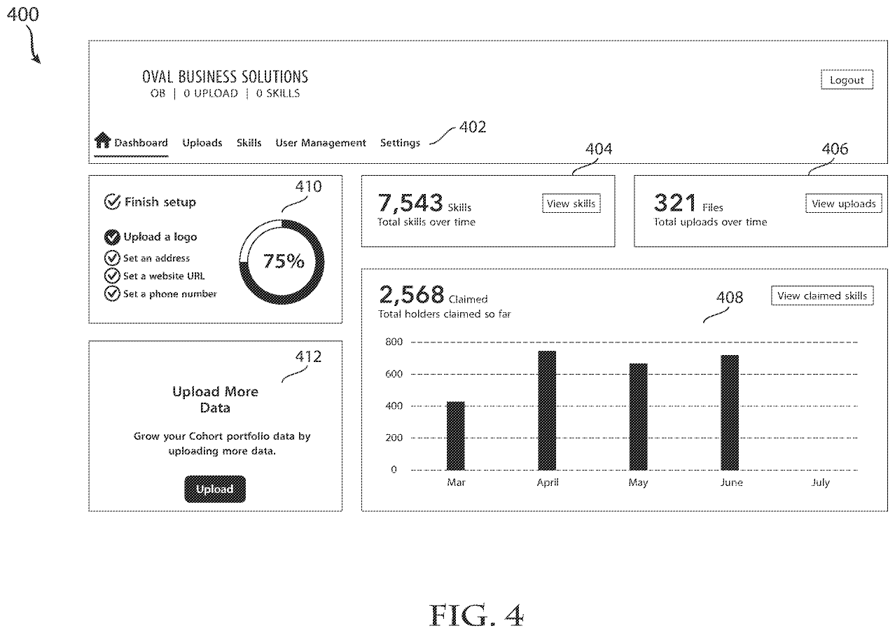

FIG. 4 illustrates a dashboard 400 that can be accessible by a skills assessor 206. The assessor might be a school, for example, and will create an account and then be able to upload student data on the qualified blockchain 100 such that users will be able to claim their qualifications and skills assessment and store them digitally as NFTs or other representations in a secure CV wallet. The dashboard 400 can include such features as selectable objects 402 for uploads, skills, user management, setting and data about the total skills assessed 404, the total uploads of files 406, the number of assessments claimed by users 408, the setup process 410, and the opportunity to upload more data 412. The interface can be provided by way of example only with respect to the general process of the assessor being able to confirm a skill, task or other assessed item associated with a user. The data or skills assessed, once provided to the extranet, are confirmed and recorded on the blockchain network 100.

In one aspect, once a skill is verified by the skills assessor 206, and recorded on the blockchain 100, a notification can be provided to the wallet 214 that a skill has been added. The user can then go into a user interface of the wallet 214 verify and/or claim the skills assessment. The user may interact with a graphical object associated with the skills assessment and may need to confirm their identity using a biometric such as facial recognition, multi-signature or other approach to confirming their identity to claim the assessment. The user can then store the verified skills assessment in the CV wallet 214 to share with employers. Certificates can be held as NFTs in one aspect and as attachments in another aspect.

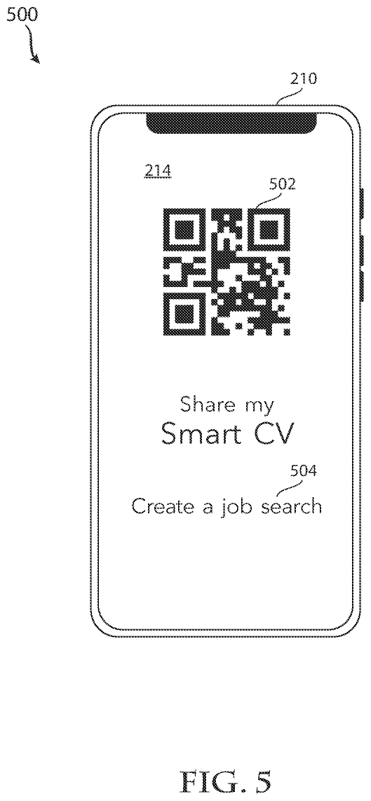

A smart CV tool can be included in the CV wallet 214 that can include a chatbot assistant and free templates to easily create tailored versions of the Smart CV: short, long, by job type, or other characteristics. The smart CV can include personal information, experience, skills and qualifications. From the CV wallet 214, the user can create NFTs of their verified assessments and qualifications and save and share the CV as a PDF or QR code link. FIG. 5 illustrates a user interface 500 on the user device 210 in which the wallet 214 provides a QR code 502 to share the smart CV. The CV Wallet can be saved or integrated as well into the Apple and Google Wallet.

The CV wallet 214 is configured to enable the user to create a job search 504 via the user interface. The user can choose which job boards they want to find jobs on and create searches based on what sort of jobs they are looking for. Employers can include identity, qualifications, skills and experience in the requested criteria. The user can get alerts when jobs match the user criteria. The user can click on those jobs and apply using the smart CV all within the wallet 214. The wallet 214 can also receive direct job offers from employers. Through the wallet 214, the user can let employers know when they are open to work. The ecosystem allows employers to find potential employees based on your skills assessments.

If an employer can identify the skills that they need (perhaps using their preferred assessment method), and verify an individual's identity, then the approach disclosed herein reduces wasted time. The approach can include the employer 208 providing to the extranet a description of the criteria for a job. The criteria might include certain skills assessment and might also include a level of verification desired (for example, low, medium or high which can correspond to self-verified, proof verified or blockchain verified). Then, the extranet 202 can manage the notifications to the user wallets 214 for those that match one or more of the criteria such as a skills match at the proper blockchain-based verification level. Because the skills achieved by the user are made more portable in the disclosed ecosystem, employers can easily identify, match and hire people with the right skills that they have already proven elsewhere.

Job offers can be made to qualified candidates who have already taken and passed relevant skills tests, where they match what the employer is looking for. The users (which can be anonymous at an initial stage) can then find out more about the job and the employer before sharing their details and accepting the offer. The employer may not know to whom the offers are presented at an initial stage. The disclosed approach can negate the need of the user to apply and can short cut the entire recruitment process. Employers 208 can pay per successful offer accepted and candidates can pick the best or most suitable offer, and the assessment companies 206 can generate revenue in the process. In one example, assessments can be carried out for free by the job seekers, and it is in the commercial interest of the assessment companies to promote it to employers.

In one aspect, an identity of potential employees might be revealed in part over time as the employer perhaps filters out potential employees. Thus, they may start out as anonymous and more and more information can be provided in stages over the process.

Using the CV wallet 214, users have complete control over their data and privacy. What they share with whom and when is under their control. The approach securely protects user data because it can be held encrypted on their phone rather than centrally. For example, data for the payment solution called “Apple Pay” is stored in a secure element on the iPhone. The secure element can be a separate secure hardware memory location that stores payment data. Similarly, the private data associated with the smart CV can similarly be stored on a secure element or the like and might only be accessed through a security protocol such as through facial recognition, or two clicks of a physical button plus facial recognition, or fingerprint or other bio-security measure. A person identification number (PIN) can be provided as well. Any number of confirming interactions can be used to retrieve the CV information from a secure location for sharing with a potential employer. The approach enables the user to prove their identity, skills, qualifications and experience, to speed up the hiring process using a secure decentralized wallet technology and digital identities to provide an overall digital identity (DID) management system.

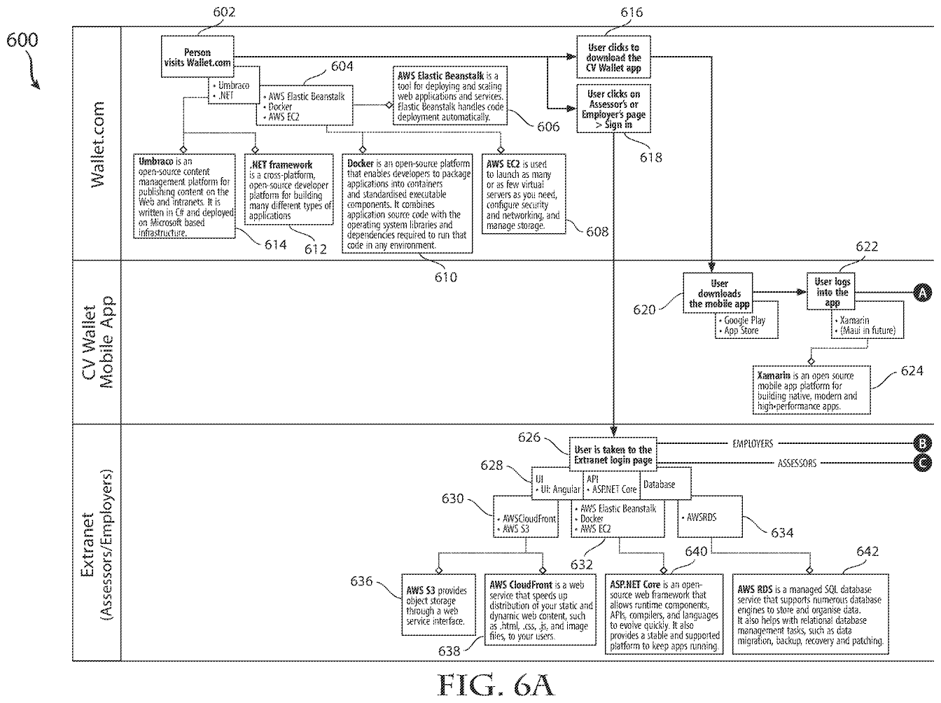

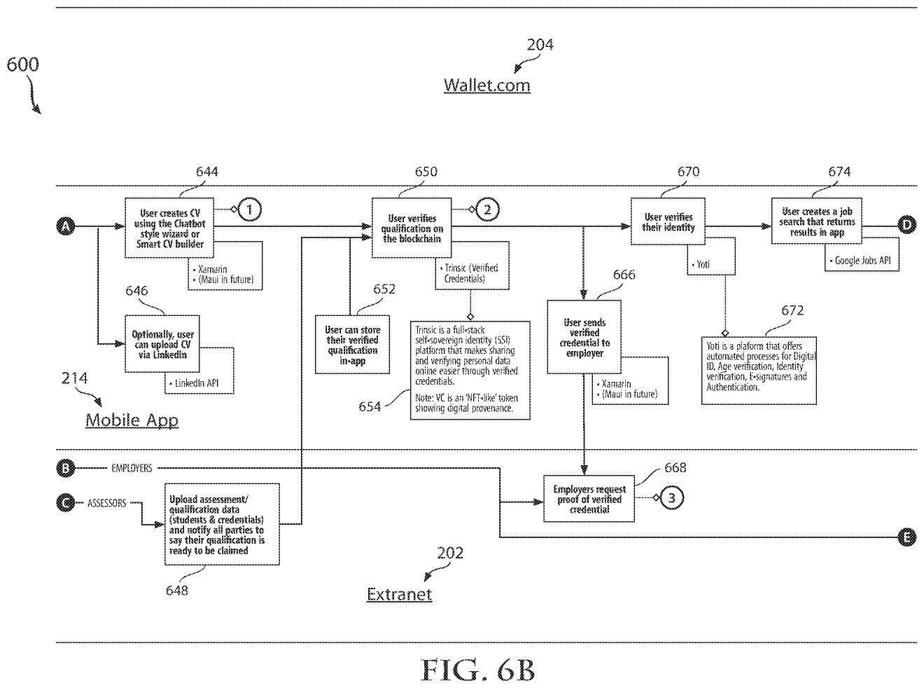

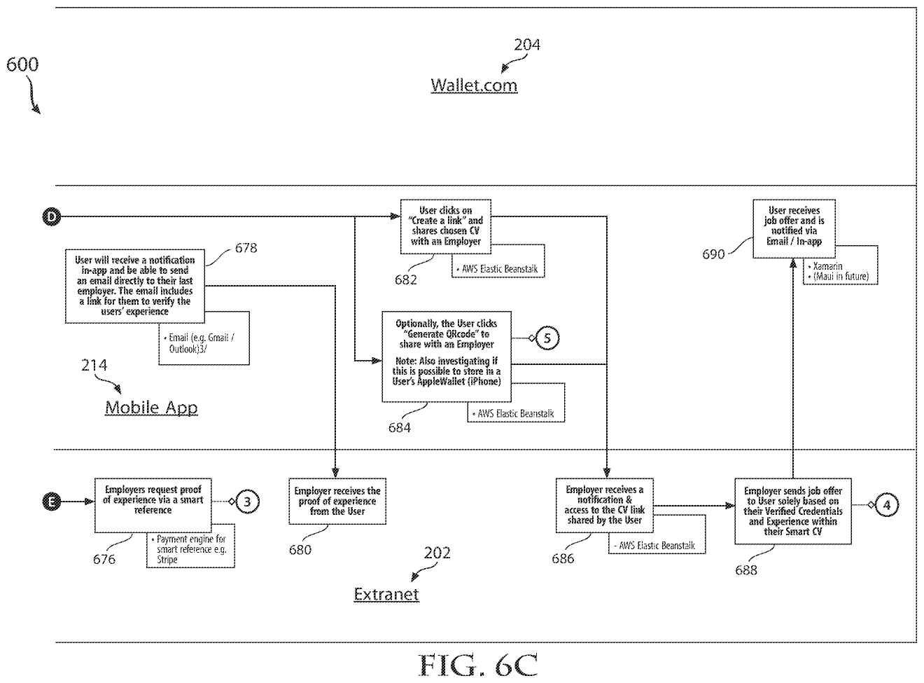

FIGS. 6A-6C show an example workflow and architecture diagram 600 for providing a CV wallet and qualified blockchain 100. Note that in the discussion below, that example tools will be mentioned to help one of skill in the art of how to build the ecosystem described herein. However, each mentioned tool is just an example and other tools or programming can be utilized to perform the functions described herein. The Wallet.com 204 can represent a website that provides access to the extranet 202 as shown. The website URL of course can be wallet.com, CVwallet.com, or any other website name. The user can visit the website 602 which can be built from some tools as the Umbraco Open-source content management system 614 and can be configured on any domain such as .com or .net. The .net framework is a cross-platform, open-source developer platform for building different applications 612. The website can use different tools such as the Amazon Web Services (AWS) Elastic Beanstalk, docker tools and AWS EC2 604. The AWS Elastic Beanstalk is a tool for deploying and scaling web applications 606. Docker is an open-source platform that enables developers to package applications into containers and standardized executable components 610. AWS ECS is used to launch as many or as few virtual servers as is needed 608. The user can access through wallet.com and download the CV wallet application 616 from an app store 212 or other database. The user can also access through the website an assessor's or employer's page and sign in 618. Thus, the website 204 is a portal to the various entities that participate in the ecosystem.

When the user downloads the CV wallet application 616 and loads the application 214 onto their mobile device and logs into the application 622. The application can be developed using Xamarin which is an open-source mobile app platform for building native, modern and high-performance application 624. Logging into the application brings the user to point A which transitions them to FIG. 6B.

When the user clicks on the assessor or employer's page, the user is transitioned to the extranet 202 for assessors and employers. The user is taken to a login page 626 which can have various features 628 such as a user interface (UI). Angular is an example tool that can be used to build the user interface. An application programming interface (API) can be another feature that can use ASP.NET Core. A database can also be provided using AWS RDS (relational database) 634 which is a managed SQL (structured query language) database service that supports numerous database engines to store and organize data 642.

The UI can be provided by AWS S3 (simple storage service) 630, 636 that provides object storage through the web service interface. An AWS Cloudfront is a web service that speeds up distribution of static and dynamic web content 638. The API/ASP.NET Core can be implemented using AWS Elastic Beanstalk, docker and the AWS EC2 tool. The ASP.NET Core 640 is an open-source web framework that allows runtime components, APIs, compilers and languages to evolve quickly and provides a stable and supported platform to keep applications running.

From the extranet 202, users can access employers at point B or assessors at point C which transition the user to FIG. 6B. At point A in FIG. 6B, the user can either create a CV using the chatbot style wizard or a smart CV builder 644. Operation 644 is also labeled as step 1 in FIG. 6B. For example, the application developed using Xamarin can enable the creation of the CV within the wallet application 214. The user can also optionally upload an existing CV via LinkedIn, or via a Microsoft Word, PDF, or some other formatted document 646.

After step 1 where the user creates the CV, the user can verify a qualification on the blockchain 650 in a step 2. The user can store their verified qualification in the application 652 or in the wallet. Transic is an example service that is a full-stack self-sovereign identity (SSI) platform that makes sharing and verifying personal data online easier through verified credentials 654. Verified credentials (VC) are similar to non-fungible tokens that show digital provenance. They can have a record stored on the blockchain 100 as well but may not formally be an NFT.

At point B in FIG. 6B, when the user logs into an employer platform, the user (which can be a representative of the employer) can request proof of a verified credential 668 at step 3. When the user is an assessor logged into the assessor platform of the extranet 202, at point C, the user can upload assessment/qualification data about students or users and notify all the parties that the uploaded qualification is ready to be claimed.

After the user verifies their qualification on the blockchain in step 2, the user can send the verified credential to the employer 666 from the wallet 214 to the extranet 202. In another step 670, the user can self-verify their identity through a tool such as Yoti 672 which is a platform that offers automated processes for digital ID, age verification, identity verification, e-signatures and authentication. The user can then create a job search 674 that returns the results in the wallet 214. The process can be done using a Google Jobs API or some other API. The next position is point D in the application 214 and point E for the extranet 202 as the operations transition to FIG. 6C.

At point E in FIG. 6C in the extranet 202, the employers can request proof of experience via a smart reference 676 at a step 3. A payment can be provided through a service such as Stripe for the smart reference as an option. The user then receives a notification in the wallet 214 and can send an email or other communication directly to their last employer. The email can include a link for them to verify the user's experience 678. Any email tool such as gmail or Outlook can be used for the communication. Other means of communication such as social media (Facebook, Instagram, and so forth) can be used for the communication as well. The employer receives the proof of experience from the user 680 at the extranet 202. At point D in FIG. 6C, the application brings the user to the ability to click on a link and share their chosen CV with an employer 682. Optionally, the user can click on a generate a QR code to share with the employer 684 as part of step 5. The code can be a QR code similar to what is shown in FIG. 5.

When the user clicks on the “create a link” option, the employer can receive a notification and access to the CV link shared by the user 686 and can then send a job offer to the user based on their verified credentials and experience within the smart CV 688 in step 4. When the job offer is sent, the user receives the job offer and is notified via email or in application 690. Other communication approaches such as through social media or other applications can be provided as well.

The referencing approach can initially start as a cost per reference approach but then can be available as a monthly “RaaS” or referencing as a service.

There are many use case scenarios using the ecosystem described herein. For example, job offers can be quickly made to qualified candidates who have already taken and passed relevant skills tests, where they match the employer qualifications. Anonymous users can find out more about the potential job and the employer before sharing their details and accepting the offer. For example, the user may accept an offer subject to conditions. The process can negate the need to apply and can short cut the entire recruitment process.

Employers may then pay per successful offer accepted, candidates can pick the best or most suitable offer, and the assessment companies generate revenue in the process. Payments can flow to assessment companies, employers and even to employees for participation in the process. Any type of employment can be covered by the disclosed approach. Nurses, programmers, doctors, human resource managers, sales people and so forth can use the disclosed system. For example, a programmer or developer may have taken an intermediate level Java course. They may take an assessment to demonstrate their new skills. The assessment can be verified and stored securely on the blockchain. The developer claims the skills assessment and stores it securely in their CV Wallet 214. A company is advertising to hire remote Java developers. The company is able to immediately verify the skill level of the developer who has applied. The company can offer the developer the job to start straight away based on their stored qualification, right to work status, and identity. The potential employee is immediately offered the job to start the next day.

In another use case, the job seeker is looking for retail work. The potential employee walks into their local shop where they have seen an ad in the window for help wanted. They can share their smart CV with the potential employer via scanning a QR code on their mobile device. The employer can immediately see the confirmed work experience at specific levels of verification. The employee can start the next day.

In another case, a student may apply for graduate programs in an accountancy firm. As part of the interview process, they take a number of different skills assessments. Whilst they don't get the job, they are able to claim the assessments they took and store them in their CV Wallet 214. Now, the user is able to prove their skills potentially for the next employer and are able to skip straight to the final interview stage with another accountancy firm. They can get the job at the second employer and because they are already Identity checked and there is no need for referencing.

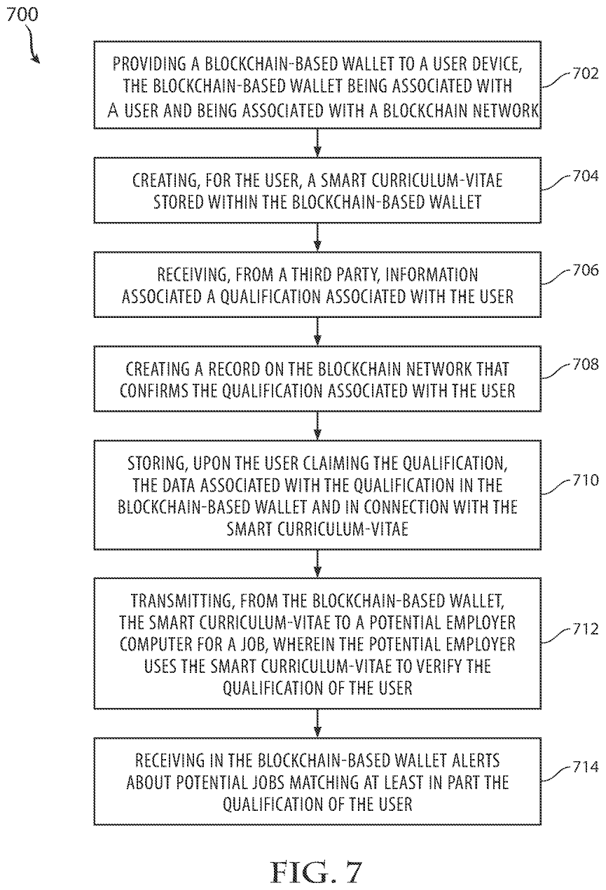

FIG. 7 illustrates an example method 700 for operating a smart CV wallet application. The method 700 includes providing a blockchain-based wallet to a user device, the blockchain-based wallet being associated with a user and being associated with a blockchain network (702), creating, for the user, a smart curriculum-vitae stored within the blockchain-based wallet (704), receiving, from a third party, information associated a qualification associated with the user (706), creating a record on the blockchain network that confirms the qualification associated with the user (708), storing, upon the user claiming the qualification, the data associated with the qualification in the blockchain-based wallet and in connection with the smart curriculum-vitae (710) and transmitting, from the blockchain-based wallet, the smart curriculum-vitae to a potential employer computer for a job, wherein the potential employer uses the smart curriculum-vitae to verify the qualification of the user (712).

The method 700 can further include receiving in the blockchain-based wallet alerts about potential jobs matching at least in part the qualification of the user (714). The smart curriculum-vitae can provide a three-level verification for each qualification in the smart curriculum-vitae. The three-level verification can include at least one or more of a self-verification, a proof verification and a blockchain verification.

The method can further include providing referencing as a service from a network-based computer system for confirming user qualifications. In another aspect, the method can include receiving a request for a job alert within the blockchain-based wallet for receiving job alerts from job information sources. The potential employer uses the smart curriculum-vitae to verify one or more of a right to work status and an identity of the user.

In yet another aspect, the method can include providing a scannable object from the blockchain-based wallet that, when scanned by a computing device, causes the blockchain-based wallet to transmit the smart curriculum-vitae to the computing device.

The method can further include verifying for a second user associated with the computing device an identity of the user and the qualification described in the smart curriculum-vitae.

The method can further include receiving a selection from a computing device associated with the potential employer regarding a level of verification for each element in the smart curriculum-vitae; and verifying each element for the potential employer according to the selection. The selection can include a first level of “self-verified”, a second level of “verified with proof” and a third level of “blockchain verified”.

The method further can include receiving from the user and within the blockchain-based wallet one or more of a job search request and a timing of when the user is open to start work.

In another aspect, the method can include providing job offers from potential employers to the blockchain-based wallet or providing a digital assistant to interact with the user to create a tailored version of the smart curriculum-vitae in terms of a length and its topical focus.

The length can include a short smart curriculum-vitae, a long smart curriculum-vitae and a topical focus of a job type. A respective non-fungible token can be created for each qualification in the smart curriculum-vitae. The smart curriculum-vitae can include a respective interactive software object that enables users to confirm respective qualifications via a reference to the blockchain network and a respective non-fungible token through interacting with respective interactive software object. The smart curriculum-vitae can be shared with another computing device via a PDF file, an AirDrop function, a QR code or from an integration with an existing payment wallet. Prior to storing, upon the user claiming the qualification, the non-fungible token associated with the qualification in the blockchain-based wallet, the method can include receiving, from the user, a claim of the qualification associated with the non-fungible token and verified on the blockchain network.

Transmitting, from the blockchain-based wallet, the smart curriculum-vitae to the potential employer computer for the job can include transmitting a link to the smart curriculum-vitae to the potential employer computer. The record on the blockchain network can include a non-fungible token.

A system can include a processor and a computer-readable storage medium storing instructions which, when executed by the processor, cause the processor to perform operations including: providing a blockchain-based wallet to a user device, the blockchain-based wallet being associated with a user and being associated with a blockchain network, creating, for the user, a smart curriculum-vitae stored within the blockchain-based wallet, receiving, from a third party, information associated a qualification associated with the user, creating a record on the blockchain network that confirms the qualification associated with the user, storing, upon the user claiming the qualification, the data associated with the qualification in the blockchain-based wallet and in connection with the smart curriculum-vitae and transmitting, from the blockchain-based wallet, the smart curriculum-vitae to a potential employer computer for a job, wherein the potential employer uses the smart curriculum-vitae to verify the qualification of the user. The operations can include receiving in the blockchain-based wallet alerts about potential jobs matching at least in part the qualification of the user. The system can include operations performed by any particular component in the system shown in FIG. 2 such as one or more of the extranet 202, the user device 210 and the blockchain 100. Typically, the system will focus on the operations of the extranet 202.

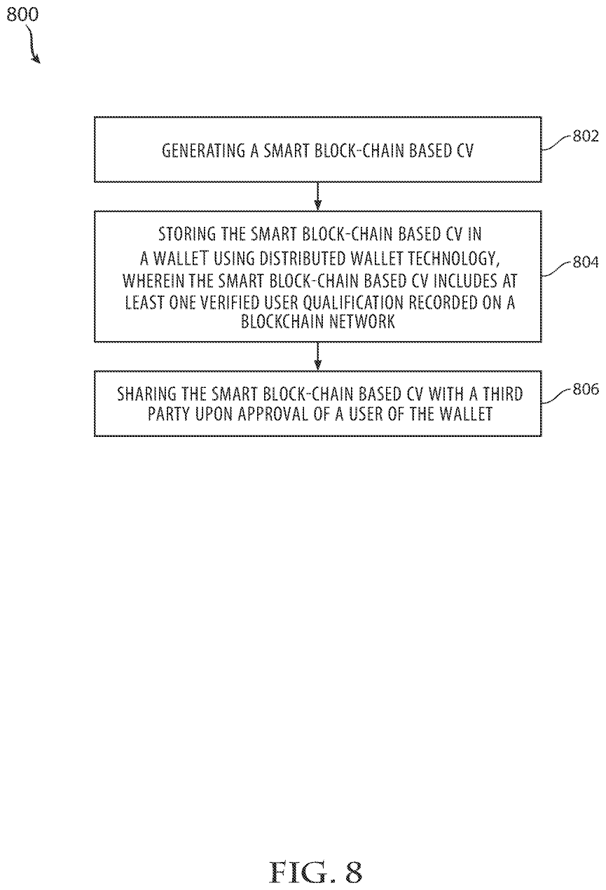

FIG. 8 illustrates an example method 800 associated with storing the CV using distributed wallet technology The method 800 includes generating a smart block-chain based CV (802), storing the smart block-chain based CV 802 in a wallet using distributed wallet technology, wherein the smart block-chain based CV can include at least one verified user qualification recorded on a blockchain network (804) and sharing the smart block-chain based CV with a third party upon approval of a user of the wallet (806).

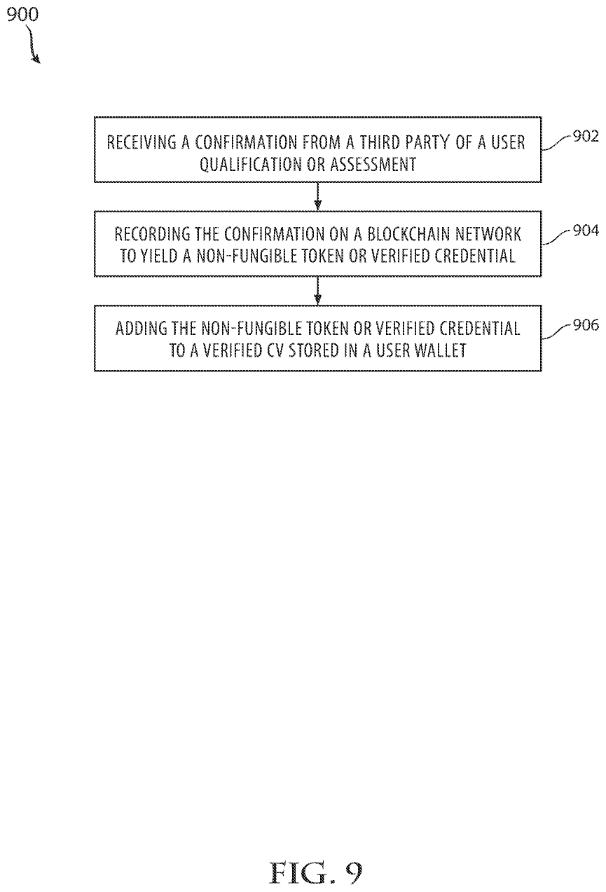

FIG. 9 illustrates an example method 900 related to storing skills assessments or qualifications as non-fungible tokens or verified credentials on a blockchain network as part of a verified CV. The method 900 includes one or more of receiving a confirmation from a third part of a user qualification or assessment (902), recording the confirmation on a blockchain network to yield a non-fungible token or verified credential (904) and adding the non-fungible token or verified credential to a verified CV stored in a user wallet (906).

A system can perform the operations of FIG. 9. The system can include a processor and a computer-readable storage media that stores instructions which, when executed by the processor, cause the processor to perform operations related to storing skills assessments or qualifications as non-fungible tokens or verified credentials on a blockchain network as part of a verified CV. The operations can include receiving a confirmation from a third part of a user qualification or assessment, recording the confirmation on a blockchain network to yield a non-fungible token or verified credential and adding the non-fungible token or verified credential to a verified CV stored in a user wallet.

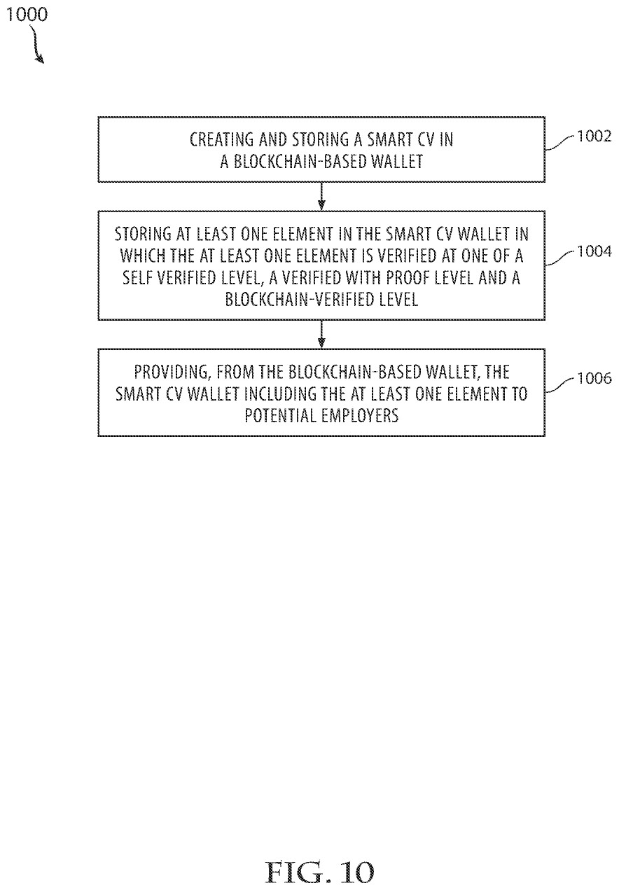

FIG. 10 illustrates a method 1000 associated with providing three levels of verification in a smart CV. The method 1000 includes creating and storing a smart CV in a blockchain-based wallet (1002), storing at least one element in the smart CV wallet in which the at least one element is verified at one of a self-verified level, a verified with proof level and a blockchain-verified level (1004) and providing, from the blockchain-based wallet, the smart CV wallet including the at least one element to potential employers (1006). The element can relate to a skills assessment, a credential, a work experience, a hobby, or any other information about the user or owner of the smart wallet.

A system can perform the operations of FIG. 10. The system can include a processor and a computer-readable storage media that stores instructions which, when executed by the processor, cause the processor to perform operations related to providing three levels of verification in a smart CV. The operations can include creating and storing a smart CV in a blockchain-based wallet, storing at least one element in the smart CV wallet in which the at least one element is verified at one of a self-verified level, a verified with proof level and a blockchain-verified level and providing, from the blockchain-based wallet, the smart CV wallet including the at least one element to potential employers.

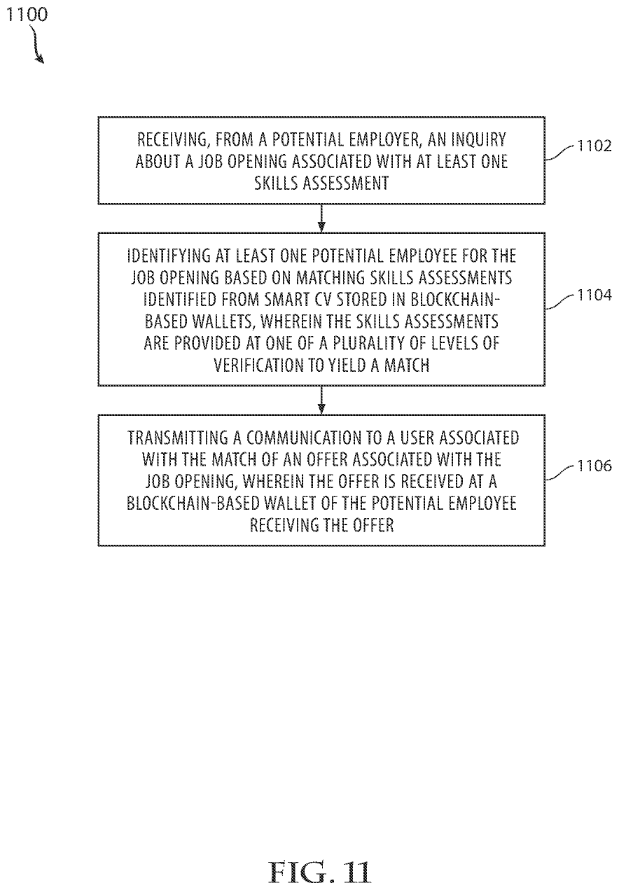

FIG. 11 illustrates another method 1100 related to making job offers directly to people based solely on skills assessments that have been completed. The method 1100 includes receiving, from a potential employer, an inquiry about a job opening associated with at least one skills assessment (1102), identifying at least one potential employee for the job opening based on matching skills assessments identified from smart CV stored in blockchain-based wallets, wherein the skills assessments are provided at one of a plurality of levels of verification to yield a match (1004) and transmitting a communication to a user associated with the match of an offer associated with the job opening, wherein the offer is received at a blockchain-based wallet of the potential employee receiving the offer (1106).

A system can perform the operations of FIG. 11. The system can include a processor and a computer-readable storage media that stores instructions which, when executed by the processor, cause the processor to perform operations related to making job offers directly to people based solely on skills assessments that have been completed. The operations can include receiving, from a potential employer, an inquiry about a job opening associated with at least one skills assessment and identifying at least one potential employee for the job opening based on matching skills assessments identified from smart CV stored in blockchain-based wallets, wherein the skills assessments are provided at one of a plurality of levels of verification to yield a match. The operations can further include transmitting a communication to a user associated with the match of an offer associated with the job opening, wherein the offer is received at a blockchain-based wallet of the potential employee receiving the offer.

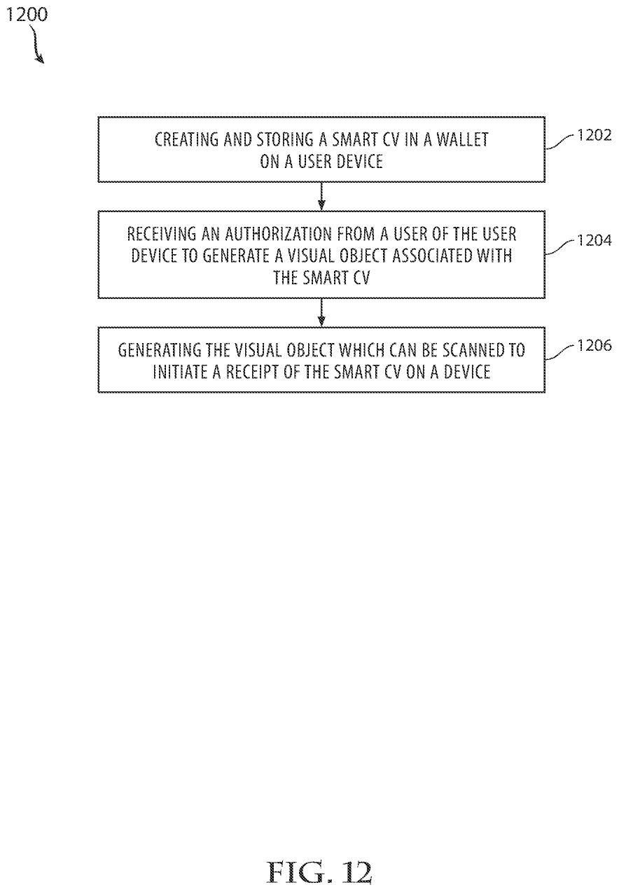

FIG. 12 illustrates another aspect of this disclosure and includes a method 1200 related to job seekers creating a unique QR code to send CVs from their mobile device. The method 1200 can include creating and storing a smart CV in a wallet on a user device (1202), receiving an authorization from a user of the user device to generate a visual object associated with the smart CV (1204), and generating the visual object which can be scanned to initiate a receipt of the smart CV on a device (1206).

A system can perform the operations of FIG. 12. The system can include a processor and a computer-readable storage media that stores instructions which, when executed by the processor, cause the processor to perform operations related to job seekers creating a unique QR code to send CVs from their mobile device. The operations can include creating and storing a smart CV in a wallet on a user device, receiving an authorization from a user of the user device to generate a visual object associated with the smart CV, and generating the visual object which can be scanned to initiate a receipt of the smart CV on a device.

The various systems disclosed above can include one or more of a wallet 214, an extranet 202, a mobile device or an application operating on a user mobile device and/or a blockchain network 100.

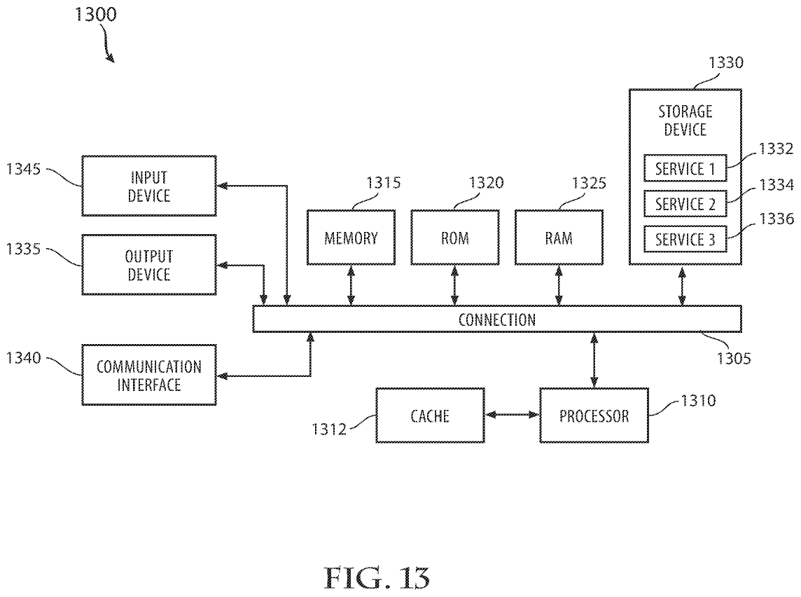

FIG. 13 illustrates a computing system architecture 1300 including various components in electrical communication with each other using a connection 1306, such as a bus. Example system architecture 1300 includes a processing unit (CPU or processor) 1304 and a system connection 1306 that couples various system components including the system memory 1320, such as read only memory (ROM) 1318 and random access memory (RAM) 1316, to the processor 1304. The system architecture 1300 can include a cache 1302 of high-speed memory connected directly with, in close proximity to, or integrated as part of the processor 1304. The system architecture 1300 can copy data from the memory 1320 and/or the storage device 1308 to the cache 1302 for quick access by the processor 1304. In one way, the cache can provide a performance boost that avoids processor 1304 delays while waiting for data. These and other modules can control or be configured to control the processor 1304 to perform various actions.

Other system memory 1320 may be available for use as well. The memory 1320 can include multiple different types of memory with different performance characteristics. The processor 1304 can include any general purpose processor and a hardware or software service, such as service 1 1310, service 2 1312, and service 3 1314 stored in storage device 1308, configured to control the processor 1304 as well as a special-purpose processor where software instructions are incorporated into the actual processor design. The processor 1304 may be a completely self-contained computing system, containing multiple cores or processors, a bus, memory controller, cache, etc. A multi-core processor may be symmetric or asymmetric.

To enable user interaction with the computing system architecture 1300, an input device 1322 can represent any number of input mechanisms, such as a microphone for speech, a touch-sensitive screen for gesture or graphical input, keyboard, mouse, motion input, speech and so forth. An output device 1324 can also be one or more of a number of output mechanisms known to those of skill in the art. In some instances, multimodal systems can enable a user to provide multiple types of input to communicate with the computing system architecture 1300. The communications interface 1326 can generally govern and manage the user input and system output. There is no restriction on operating on any particular hardware arrangement and therefore the basic features here may easily be substituted for improved hardware or firmware arrangements as they are developed.

Storage device 1308 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1316, read only memory (ROM) 1318, and hybrids thereof.

The storage device 1308 can include services 1310, 1312, 1314 for controlling the processor 1304. Other hardware or software modules are contemplated. The storage device 1308 can be connected to the system connection 1306. In one aspect, a hardware module that performs a particular function can include the software component stored in a computer-readable medium in connection with the necessary hardware components, such as the processor 1304, connection 1306, output device 1324, and so forth, to carry out the function.

For clarity of explanation, in some instances the present technology may be presented as including individual functional blocks including functional blocks including devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

Claim Clauses for this application include:

Clause 1. A method comprising: providing a blockchain-based wallet to a user device, the blockchain-based wallet being associated with a user and being associated with a blockchain network; creating, for the user, a smart curriculum-vitae stored within the blockchain-based wallet; receiving, from a third party, information associated a qualification associated with the user; creating a record on the blockchain network that confirms the qualification associated with the user; storing, upon the user claiming the qualification, data associated with the qualification in the blockchain-based wallet and in connection with the smart curriculum-vitae; and transmitting, from the blockchain-based wallet, the smart curriculum-vitae to a potential employer computer for a job, wherein a potential employer uses the smart curriculum-vitae to verify the qualification of the user.

Clause 2. The method of clause 1, further comprising: receiving, in the blockchain-based wallet, alerts about potential jobs matching at least in part the qualification of the user.

Clause 3. The method of any previous clause, wherein the smart curriculum-vitae provides a three-level verification for each qualification in the smart curriculum-vitae.

Clause 4. The method of any previous clause, wherein the three-level verification comprises at least one or more of a self-verification, a proof verification and a blockchain verification.

Clause 5. The method of any previous clause, further comprising: providing referencing as a service from a network-based computer system for confirming user qualifications.

Clause 6. The method of any previous clause, further comprising: receiving a request for a job alert within the blockchain-based wallet for receiving job alerts from job information sources.

Clause 7. The method of any previous clause, wherein the potential employer uses the smart curriculum-vitae to verify one or more of a right to work status and an identity of the user.

Clause 8. The method of any previous clause, further comprising: providing a scannable object from the blockchain-based wallet that, when scanned by a computing device, causes the blockchain-based wallet to transmit the smart curriculum-vitae to the computing device.

Clause 9. The method of any previous clause, wherein the scannable object comprises a QR code.

Clause 10. The method of any previous clause, further comprising: verifying for a second user associated with the computing device an identity of the user and the qualification described in the smart curriculum-vitae.

Clause 11. The method of any previous clause, further comprising: receiving a selection from a computing device associated with the potential employer regarding a level of verification for each element in the smart curriculum-vitae; and verifying each element for the potential employer according to the selection.

Clause 12. The method of any previous clause, where the selection comprises a first level of self-verified, a second level of proof verified and a third level of blockchain verified.

Clause 13. The method of any previous clause, further comprising: receiving, from the user and within the blockchain-based wallet, one or more of a job search request and a timing of when the user is open to start work.

Clause 14. The method of any previous clause, further comprising: providing job offers from potential employers to the blockchain-based wallet.

Clause 15. The method of any previous clause, further comprising: providing a digital assistant to interact with the user to create a tailored version of the smart curriculum-vitae in terms of a length and its topical focus.

Clause 16. The method of any previous clause, wherein the length comprises a short smart curriculum-vitae, a long smart curriculum-vitae and a topical focus of a job type.

Clause 17. The method of any previous clause, wherein a respective non-fungible token is created for each qualification in the smart curriculum-vitae.

Clause 18. The method of any previous clause, wherein the smart curriculum-vitae comprises a respective interactive software object that enables users to confirm respective qualifications via a reference to the blockchain network and a respective non-fungible token through interacting with respective interactive software object.

Clause 19. The method of any previous clause, wherein the smart curriculum-vitae is shared with another computing device via a PDF file, an AirDrop function, a QR code or from an integration with an existing payment wallet.

Clause 20. The method of any previous clause, wherein prior to storing, upon the user claiming the qualification, the respective non-fungible token associated with the qualification in the blockchain-based wallet, the method comprises: receiving, from the user, a claim of the qualification associated with the respective non-fungible token and verified on the blockchain network.

Clause 21. The method of any previous clause, wherein transmitting, from the blockchain-based wallet, the smart curriculum-vitae to the potential employer computer for the job comprises transmitting a link to the smart curriculum-vitae to the potential employer computer.

Clause 22. The method of any previous clause, wherein the record on the blockchain network comprises a non-fungible token.

Clause 23. A system comprising: a processor; and a computer-readable storage device storing instructions which, when executed by the processor, cause the processor to perform operations comprising: creating, for a user, a smart curriculum-vitae stored within a blockchain-based wallet using a blockchain network; receiving, from a third party, information associated a qualification associated with the user; creating a record on the blockchain network that confirms the qualification associated with the user; storing, upon the user claiming the qualification, data associated with the qualification in the blockchain-based wallet and in connection with the smart curriculum-vitae; and transmitting, from the blockchain-based wallet, the smart curriculum-vitae to a potential employer computer for a job, wherein a potential employer uses the smart curriculum-vitae to verify the qualification of the user.

Clause 24. A system includes means for performing any operation or step of any of clauses 1-22.

Clause 25. A computer-readable storage medium storing instructions which, when executed by one or more processors, cause the one or more processors to perform any operation or step of any of clauses 1-22.

We claim:

1. A method comprising:
providing a blockchain-based wallet to a user device, the blockchain-based wallet being associated with a user and being associated with a blockchain network;
creating, for the user, a smart curriculum-vitae stored within the blockchain-based wallet;
receiving, from a third party, information associated a qualification associated with the user;
creating a record on the blockchain network that confirms the qualification associated with the user;
storing, upon the user claiming the qualification, data associated with the qualification in the blockchain-based wallet and in connection with the smart curriculum-vitae; and
transmitting, from the blockchain-based wallet, the smart curriculum-vitae to a potential employer computer for a job, wherein a potential employer uses the smart curriculum-vitae to verify the qualification of the user.

2. The method of claim 1, further comprising:
receiving, in the blockchain-based wallet, alerts about potential jobs matching at least in part the qualification of the user.

3. The method of claim 1, wherein the smart curriculum-vitae provides a three-level verification for each qualification in the smart curriculum-vitae and wherein the three-level verification comprises at least one or more of a self-verification, a proof verification and a blockchain verification.

4. The method of claim 1, further comprising:
providing referencing as a service from a network-based computer system for confirming user qualifications.

5. The method of claim 1, further comprising:
receiving a request for a job alert within the blockchain-based wallet for receiving job alerts from job information sources.

6. The method of claim 1, wherein the potential employer uses the smart curriculum-vitae to verify one or more of a right to work status and an identity of the user.

7. The method of claim 1, further comprising:
providing a scannable object from the blockchain-based wallet that, when scanned by a computing device, causes the blockchain-based wallet to transmit the smart curriculum-vitae to the computing device.

8. The method of claim 7, wherein the scannable object comprises a QR code.

9. The method of claim 7, further comprising:
verifying for a second user associated with the computing device an identity of the user and the qualification described in the smart curriculum-vitae.

10. The method of claim 1, further comprising:
receiving a selection from a computing device associated with the potential employer regarding a level of verification for each element in the smart curriculum-vitae; and
verifying each element for the potential employer according to the selection.

11. The method of claim 10, where the selection comprises a first level of self-verified, a second level of proof verified and a third level of blockchain verified.

12. The method of claim 1, further comprising:
receiving, from the user and within the blockchain-based wallet, one or more of a job search request and a timing of when the user is open to start work.

13. The method of claim 1, further comprising:
providing job offers from potential employers to the blockchain-based wallet.

14. The method of claim 1, further comprising:
providing a digital assistant to interact with the user to create a tailored version of the smart curriculum-vitae in terms of a length and its topical focus.

15. The method of claim 14, wherein the length comprises a short smart curriculum-vitae, a long smart curriculum-vitae and a topical focus of a job type and wherein a respective non-fungible token is created for each qualification in the smart curriculum-vitae.

16. The method of claim 1, wherein the smart curriculum-vitae comprises a respective interactive software object that enables users to confirm respective qualifications via a reference to the blockchain network and a respective non-fungible token through interacting with respective interactive software object and wherein the smart curriculum-vitae is shared with another computing device via a PDF file, an AirDrop function, a QR code or from an integration with an existing payment wallet.

17. The method of claim 16, wherein prior to storing, upon the user claiming the qualification, the respective non-fungible token associated with the qualification in the blockchain-based wallet, the method comprises:
receiving, from the user, a claiming the qualification associated with the respective non-fungible token and verified on the blockchain network.

18. The method of claim 1, wherein transmitting, from the blockchain-based wallet, the smart curriculum-vitae to the potential employer computer for the job comprises transmitting a link to the smart curriculum-vitae to the potential employer computer and wherein the record on the blockchain network comprises a non-fungible token.

19. A system comprising:
a processor; and
a computer-readable storage device storing instructions which, when executed by the processor, cause the processor to perform operations comprising:
creating, for a user, a smart curriculum-vitae stored within a blockchain-based wallet using a blockchain network;
receiving, from a third party, information associated a qualification associated with the user;
creating a record on the blockchain network that confirms the qualification associated with the user;
storing, upon the user claiming the qualification, data associated with the qualification in the blockchain-based wallet and in connection with the smart curriculum-vitae; and
transmitting, from the blockchain-based wallet, the smart curriculum-vitae to a potential employer computer for a job, wherein a potential employer uses the smart curriculum-vitae to verify the qualification of the user.

20. A computer-readable storage device storing instructions which, when executed by one or more processor, cause the one or more processor to perform operations comprising:
creating, for a user, a smart curriculum-vitae stored within a blockchain-based wallet using a blockchain network;
receiving, from a third party, information associated a qualification associated with the user;
creating a record on the blockchain network that confirms the qualification associated with the user;
storing, upon the user claiming the qualification, data associated with the qualification in the blockchain-based wallet and in connection with the smart curriculum-vitae; and
transmitting, from the blockchain-based wallet, the smart curriculum-vitae to a potential employer computer for a job, wherein a potential employer uses the smart curriculum-vitae to verify the qualification of the user.
